(19) United States
(12) Patent Application Publication
(10) Pub. No.: US 2019/0335767 A1
(43) Pub. Date: Nov. 7, 2019

(54) METHOD FOR PREPARING FROZEN FOODS AND FROZEN FOODS OF PREDOMINANTLY PLANT ORIGIN

(71) Applicant: INDUSTRIE ROLLI ALIMENTARI S.P.A., Roseto Degli Abruzzi (IT)

(72) Inventor: Gian Paolo ROLLI, Roseto Degli Abruzzi (IT)

(21) Appl. No.: 16/343,992

(22) PCT Filed: Oct. 20, 2016
(86) PCT No.: PCT/IT2016/000246

§ 371 Date: Apr. 22, 2019

(51) Int. Cl. A21D 15/02; A21D 13/41; A21D 13/43

(52) U.S. Cl. CPC A21D 15/02; A21D 13/43; A21D 13/41

(57) ABSTRACT

A method for preparing frozen foods includes the steps of
washing vegetables in order to eliminate any residues;
subjecting the vegetables to mechanical treatment in order to isolate the edible part thereof; and
cutting the vegetables into small parts. Then,
the small parts are cooked and frozen
to a temperature comprised between −10° C. and −30° C. The method further includes the steps of
measuring predefined quantities of ingredients which include the small parts of vegetables, egg white and at least one regulator for parameters such as flavor enhancement, flavoring, and texture;
homogenizing the ingredients;
distributing the mixture on at least one surface in order to generate layers thereof of predefined dimensions;
freezing the layers; and
subjecting the layers to surface topping with ingredients chosen from among tomato sauce, cheese, vegetables, soy products, meat, meat products, fish, fish products, oils, and fats.

### TECHNICAL FIELD

The present disclosure relates to a method for preparing frozen foods, in particular for preparing pizzas, focaccia bread and the like. The present disclosure also extends its protection to frozen foods, of the type of pizzas, focaccia bread and the like, of predominantly plant origin.

### BACKGROUND

The innovation is located in the progression of the current sociocultural context that sees increasing attention being given over to diet as a key element in preserving the psychological and physical well-being of the person.

Various information campaigns, including by official bodies, highlight that a healthy and balanced diet is a determining factor in keeping the human body healthy.

In this regard, for example, the World Health Organization has said that a balanced and healthy diet can prevent the onset of at least ⅓ of tumors and cardiovascular diseases.

There are at least four key aspects that distinguish a balanced diet.

The first is choosing foods correctly. Furthermore, it is necessary to tailor the amounts eaten to the actual nutritional needs of the individual, which depend on age, sex, their level of physical activity and the like.

Another key aspect is checking the nutritional values associated with the foods that one eats and furthermore it is likewise important to pay attention to the changes that the foods can undergo with conservation and cooking.

One of the reference models followed for creating a healthy diet is the food pyramid, which distinguishes the foods that can be eaten several times a day (fruit and vegetables) from the foods whose consumption should be limited or occasional (condiments, sweets, and alcoholic beverages).

Fruit and vegetables in fact are very important for a healthy diet since they are an important source of fibers, an essential element in the digestive process; furthermore they are rich, both in vitamins and minerals that are essential for the proper operation of the physiological mechanisms, and in antioxidants that have a protective action on the body.

In order to stimulate the consumption of fruit and vegetables, therefore, new recipes are continually developed that make it possible to boost the opportunities for their consumption.

Owing to their high calorific value and the common types of allergy and intolerance that they trigger, many cereals and cereal products need to be greatly limited in diets. For this reason, the use is known of food products of plant origin which are seen as possible substitutes for some types of dough: the advantage is to reduce the amount of cereals in the body and, at the same time, increase the amount of vegetables (the beneficial effects of which are undisputed).

In reality, some cereal-based foods cannot be substituted with other ingredients, and they must therefore be eliminated from the diet of many people (who therefore find themselves having to follow a rather monotonous dietary regime).

### SUMMARY

The aim of the present disclosure is to solve the above mentioned problems, moreover offering a commercial response to the needs created by them, by devising a method for providing frozen foods that makes it possible to minimize, even eliminate, cereal flours from foods such as pizzas, focaccia bread and the like.

Within this aim, the disclosure provides a packaged frozen food of predominantly plant origin which is easy and quick to prepare and which has a useful commercial life, i.e. shelf life, equal to at least 18 months.

The disclosure also provides a packaged frozen food of predominantly plant origin which can be consumed by users who are subject to allergies to and/or intolerance of cereals and related flours.

The present disclosure further provides a method for preparing cut and frozen vegetables which is low cost, easily and practically implemented and safe m use.

This aim and these and other advantages which will become better apparent hereinafter are achieved by providing a method for preparing frozen foods which comprises the steps of:
washing vegetables in order to eliminate any residues;
subjecting said vegetables to mechanical treatment in order to isolate the edible part thereof;
cutting said vegetables into small parts having dimensions comprised between 2 mm and 20 mm, through the use of a cutting device;
cooking said small parts by way of subjection to boiling, steaming and the like;
freezing said cooked small parts by way of a freezer to a temperature comprised between −10° C. and −30° C.;
measuring predefined quantities of ingredients which comprise said small parts of vegetables, egg white and at least one regulator for parameters such as flavor enhancement, flavoring, texture and the like;
homogenizing said ingredients by way of apparatuses for cutting and mixing, producing a homogeneous mixture;
distributing said mixture on at least one surface in order to generate layers thereof of predefined dimensions;
freezing said layers by way of a freezer to a temperature comprised between −10° C. and −30° C.; and
subjecting said layers to surface topping with ingredients chosen from among tomato sauce, cheese, vegetables, soy products, meat, meat products, fish, fish products, oils, fats and the like.

Such aim and such advantages are also achieved by providing a frozen food of predominantly plant origin, characterized in that it is of the type of a pizza, a focaccia bread and the like which comprises a base and a topping, said base comprising at least one vegetable in a percentage by weight comprised between 40% and 90%, egg white in a percentage by weight comprised between 2% and 20% and at least one regulator for parameters such as flavor enhancement, flavoring, texture and the like in a percentage by weight comprised between 0.1% and 35%.

### DETAILED DESCRIPTION OF THE DISCLOSURE

Further characteristics and advantages of the disclosure will become better apparent from the detailed description that follows of a preferred, but not exclusive, embodiment of the method for preparing frozen foods and of the corresponding food provided according to such method.

It should be noted that in the present discussion the term “vegetables” identifies all types of plants except for cereals, which are exemplified in brief (without this constituting a limitation that would exclude other types of plants from the generic definition of vegetables used in the present discussion) in the following list: fruit vegetables (such as drupes, berries, hesperidia and pomes, and therefore tomatoes, zucchini, eggplants, cucumbers, pumpkins and bell peppers), flower vegetables (such as artichokes, cauliflowers, broccoli, asparagus, zucchini flowers etc), seed vegetables (such as legumes, i.e. all beans, chickpeas, chicklings, lentils, peas, broad beans, lupins etc), leaf vegetables (such as lettuce, radicchio, rocket, valerian, borage, spinach, puntarelle, cabbage, white cabbage, chard, chicory, dandelion etc), stem or bulb vegetables (such as celery, fennel, cardoon etc), tuber vegetables (such as potatoes, sweet potatoes, Jerusalem artichokes, carrots, turnips, parsnips, daikon, beetroot etc) and bulb vegetables (such as garlic, onions, scallions, leeks etc).

The method for preparing frozen foods according to the disclosure involves a series of consecutive steps to be carried out in order to obtain a frozen food of predominantly plant origin which is presented to the consumer as a pizza, focaccia bread and the like.

A first step entails washing the vegetables in order to eliminate any residues: it is in fact essential to clean the vegetables from any residues of soil or of other substances and materials that may have been accumulated during the harvest.

In order to validate the washing operations it is also possible to proceed with checking through the use of a device of the type of a metal detector, X-ray detectors and the like, in order to guard against the presence of foreign objects among the washed vegetables.

It should be noted that such checking operation also can be carried out at any subsequent step of storage.

At this point, during a second step the vegetables can be subjected to mechanical treatment in order to isolate the edible part thereof it must in fact be remembered that many vegetables have waste parts that must be removed before beginning the specific processes designed to obtain the end product.

A third step entails cutting the vegetables into small parts having dimensions comprised between 2 mm and 20 mm, through the use of a cutting device.

In particular, the step produces cubes, disks, granules or in any case small, discrete pieces (frozen) which will facilitate the successive steps which involve combining these with other ingredients (they will be mixed together easily).

Then a fourth step follows in which the small parts of vegetables provided previously are cooked by way of subjection to boiling, steaming and the like. It should be noted that this is not true cooking, and effectively it is more correctly described as scalding or mild thermal treatment (such as parboiling, brief steaming, microwave parcooking and the like), with the aim of generating an enzymatic inactivation/deactivation.

The cooked (more correctly, subjected to a mild thermal treatment) small parts will subsequently be frozen during a fifth step: the freezing will be done in a special freezer to a temperature comprised between −10° C. and −30° C. (generally the preferred temperature for freezing is in the neighborhood of −20° C.).

The sixth step entails measuring the ingredients according to predefined quantities.

The ingredients for providing a food, of the type of a pizza, focaccia bread and the like (in particular the base of the pizza on which a topping will be distributed), in their simplest version comprise the small parts of vegetables that were cooked previously (more correctly, subjected to a mild thermal treatment) and frozen, egg white, and at least one regulator for parameters such as flavor enhancement, flavoring, texture and the like.

The ingredients thus mixed will subsequently be subjected to homogenization during a seventh step of the method according to the disclosure: such homogenization of the ingredients will be carried out by way of apparatuses for cutting and mixing, producing a homogeneous mixture.

An eighth step entails distributing the mixture obtained previously on at least one surface, in order to generate layers thereof of predefined dimensions (by way of devices for pouring, rolling, forming, molding and the like).

Such layers will constitute the bases of the pizza or the main layer of the focaccia bread, which can be (as will be seen below) topped according to taste and production requirements.

Such layers in a subsequent step (the ninth) will then be frozen again by way of a freezer to a temperature comprised between −10° C. and −30° C. (in this case too the preferred solution is that the temperature to which the layers will be brought is around −20° C.).

The tenth and final step of the method according to the disclosure entails subjecting the layers to surface topping with ingredients chosen from among tomato sauce, cheese, vegetables, soy products, meat, meat products, fish, fish products, oils, fats and the like.

Such topping process is entirely similar to the process that is usually carried out for pizzas and focaccia bread of the conventional type.

It should be noted that a possible and advantageous (in terms of implementation and commercial) implementation of the method according to the disclosure can also comprise an additional step of arranging the layers constituted by the frozen mixture which were provided previously, prior to subjecting them to topping, inside adapted containers and proceeding with a respective precooking (this embodiment is the one that ensures an end product of better quality and usability).

Such precooking is appropriate (and in many cases necessary) since it is a precooked food product. The same ingredients with which to provide the topping (which are added onto the layers during the step of topping) are previously subjected to cooking (when necessary) and then measured in order to be frozen on the layer so that the end user needs only heat it in order to restore the organoleptic properties of the various ingredients.

In such optimized version of the method according to the disclosure, it should be noted that it will also be convenient to spray a predefined quantity of water on the layers at the end of the topping process: the water, during the subsequent freezing, will define a protective film that will enclose the frozen food of predominantly plant origin (of the type of a pizza, focaccia bread and the like) thus facilitating a better conservation thereof

Such subsequent freezing of the layers, topped and sprayed with water, will be done by way of a freezer, to a temperature comprised between −10° C. and −30° C. (in this case too it should be noted that freezing temperatures in the neighborhood of −20° C. will be preferred).

In this manner it will then be possible to proceed with the packaging of each topped, water-sprayed and frozen layer (which will have the appearance, in every way, of a traditional pizza, focaccia bread and the like).

The individual packages (which can contain one or more frozen foods according to the disclosure) can be frozen and stored in a freezer at a temperature comprised between −10° C. and −30° C. (freezing temperatures in the neighborhood of −20° C. will be preferred).

The possibility is not ruled out that the individual packages could be sold to the end user merely refrigerated (therefore not frozen).

In such case the shelf life would be between 1 and 10 weeks, as a function of the type of packaging (e.g. the shelf life will be longer if a modified atmosphere and/or an active packaging is used).

It should be noted that the at least one regulator for parameters such as flavor enhancement and flavoring can positively comprise at least one substance chosen from among kitchen salt, in a quantity of up to 1% of the total by weight, cheese, in a quantity of up to 20% of the total by weight, and at least one part of an aromatic plant, in a quantity of up to 2% of the total by weight.

In particular the cheese can be cheese of the “grana” or Parmesan type (such as for example long-matured cheeses like Parmigiano Reggiano, Grana Padano, Grana Trentino and the like): in order to provide products that are suitable also for vegan and/or vegetarian consumers, it should be noted that a cheese for vegans can be adopted (such as for example cheeses that use plant rennet and/or cheeses of completely plant origin used as substitutes for traditional cheeses).

The possibility is not ruled out of using different cheeses, such as pulled-curd cheeses, such as for example mozzarella.

It should further be noted that the at least one regulator of texture can instead conveniently comprise at least one cereal flour, in a quantity of up to 60% of the total by weight.

If a cereal flour is adopted among the ingredients, it should be noted that the addition of a conventional raising agent can also be convenient.

Obviously, recipes can be created that are completely free from cereal flours, in order to form part of diets or dietary regimes that eliminate the use of such ingredients, while versions can be provided that do comprise flours if it is desired to provide foods (focaccia bread, pizzas) constituted predominantly by plants which are more similar (from an organoleptic viewpoint) to traditional ones.

It is useful to point out furthermore that between the step of freezing the cooked small parts of vegetables (fourth step) and the step of measuring predefined quantities of ingredients (fifth step) there can positively be an intermediate step of storing and transferring the cooked and frozen small parts of vegetables.

In fact it could be useful to prepare the small parts of vegetables and freeze them proximate to the place of cultivation in order to ensure the freshness and the quality of the horticultural raw material in use, and later proceed with the storage and transfer thereof when frozen (so that their organoleptic properties cannot be subjected to any degradation).

From an implementation point of view it should be noted that the step of distributing the mixture (which is constituted by the mixed and homogenized ingredients) on at least one surface, in order to generate layers of mixture of predefined dimensions, is carried out by way of a forming unit.

This can have forms and/or molds into which to pour the mixture which are of any shape, for example layers can be made that are square, rectangular and circular, although the possibility is not ruled out of providing different geometric and/or imaginative shapes.

The frozen food of predominantly plant origin according to the present disclosure is of the type of a pizza, focaccia bread and the like.

Such food comprises a base and a topping.

The base, in turn, comprises:
at least one vegetable in a percentage by weight comprised between 40% and 90%,
egg white in a percentage by weight comprised between 2% and 20%,
at least one regulator for parameters such as flavor enhancement, flavoring, texture and the like in a percentage by weight comprised between 0.1% and 35%.

More specifically, it should be noted that in an embodiment of undoubted practical and applicative interest the at least one vegetable is present in a percentage by weight comprised between 60% and 80% and that the egg white is present in a percentage by weight comprised between 5% and 10%.

In the context of such particularly advantageous embodiment, the at least one regulator for parameters such as flavor enhancement, flavoring and the like can effectively comprise kitchen salt, in a percentage not greater than 0.5% by weight on the total, cheese, preferably grated, crumbled and the like, in a percentage not greater than 25% by weight on the total, and at least one part of an aromatic plant, in a percentage of up to 2% by weight on the total.

In this case too it should be noted that the cheese (grated, crumbled and the like) can be a “grana” or Parmesan type cheese of the conventional type and/or of the type specifically intended for vegan consumers. However, the possibility is not ruled out of adopting different types of cheese.

The at least one part of an aromatic plant will be selected from among leaves, tubers, sterns, flowers, bulbs of aromatic plants such as oregano, basil, garlic, onion, thyme, marjoram, rosemary, sage and the like.

In a possible embodiment, at least one regulator of the texture of the mixture of ingredients that constitute the base (meaning the texture of the base before it is subjected to cooking) further comprises at least one cereal flour, in a percentage not higher than 60% by weight on the total.

Since the presence of a cereal flour renders the food according to the disclosure unsuitable for specific diets and dietary regimes, it should be noted that this possible version constitutes a non-exclusive variation, which can exist on the market alongside the version that is completely free from cereal flours.

It should be noted that the topping can comprise ingredients selected from among tomato sauce, cheese, vegetables, soy products, meat, meat products, fish, fish products, oils, fats and the like.

The topping, for example, can be entirely similar to that used for traditional pizzas and, as in traditional pizzas, it can take the form of a plurality of different versions in order to suit the various tastes of the end consumers.

It should be noted that all the vegetables used can comprise a lower pesticide residue than a predefined threshold of 0.01 mg/Kg.

Alternatively, an embodiment is likewise possible in which the vegetables used are of the type originating from organic agriculture.

In this case, the entire food product can be qualified as organic, because the other topping ingredients can also be obtained with organic cultivation and/or livestock farming methods.

Generally, each food according to the disclosure (in particular of the type of pizza, focaccia bread and the like) is individually packaged: such packet will be at least partially constituted by at least one material selected from among ethylene vinyl alcohol (EVOH), polyamide (PA), polypropylene (PPL), polyethylene (PE), lignin, cartene®, polymers derived from maize, cellulose (of plant origin), paper, or cardboard.

A particularly pleasing version, from an organoleptic point of view, which furthermore makes it possible to obtain a texture on the palate that is particularly close to that of a traditional pizza or focaccia bread, involves the use of cauliflower as the vegetable that constitutes the raw material.

The possibility is not ruled out of using any other type of vegetables.

The agricultural process of obtaining vegetables to be used as raw material is preferably implemented by following the provisions of regulations for integrated production, i.e. a set of legally binding specific plant protection techniques and indications to be adopted for each crop and regulated, in Italy, by specific regional regulations.

Such regulations can preferably be applied more restrictively with the objective of ensuring a level of pesticide residues lower than 0.01 mg/Kg.

Such condition therefore makes it possible to classify the vegetables as “free from pesticide residues” or “pesticide-free”.

It should be noted that, in order to render each batch of packaged frozen food product of agricultural origin traceable, all the data corresponding to each step can positively be cataloged in a specific database and associated with a corresponding identification string (batch code shown on the packages with which the food product will be sold).

The information about the food according to the disclosure can be printed directly on the respective container or on a strip that could wrap around the package, if the container takes the form of a box-like body, for example a tray.

### Example of Implementation

The food according to the disclosure, according to a particular recipe, can have the appearance and characteristics of a “pizza margherita” of the conventional type. The substantial difference is that the base of such food will be constituted by a mixture that is predominantly constituted by cauliflower (instead of a mixture of cereal flours and yeast) in conformance with the following recipe.

BASE (about 140 g)

72% CAULIFLOWER

11% GRATED CHEESE OF “GRANA” OR PARMESAN TYPE

11% CHOPPED MOZZARELLA

0.2% KITCHEN SALT

0.07% OREGANO

0.04% BASIL

0.04% GARLIC

5.6% EGG WHITE

TOPPING (about 15 g)

98.5% TOMATO PUREE+PULP

1% KITCHEN SALT

0.5% CORNSTARCH

to which is added 15 g of SLICED MOZZARELLA.

The food thus provided, although gluten free and comprising an extremely low calorific value, has organoleptic characteristics that are entirely similar to those of a traditional pizza, therefore combining the advantages associated with the dietary consumption of plant products (correct intake of nutrients and fibers and low calorific content) with the pleasure and flavor of consuming a pizza.

Advantageously the present disclosure solves the above mentioned problems, moreover offering a commercial response to the needs created by them, by devising a method for providing frozen foods that makes it possible to minimize, even eliminate, cereal flours from foods such as pizzas, focaccia bread and the like.

Positively the disclosure provides a packaged frozen food of predominantly plant origin which is easy and quick to prepare and which has a useful commercial life, i.e. shelf life, equal to at least 18 months.

Conveniently, the packaged frozen food of predominantly plant origin according to the disclosure can be consumed by users who are subject to allergies to and/or intolerance of cereals and flours thereof

Positively the method for preparing cut and frozen vegetables is easily and practically implemented and low cost: such characteristics render the method according to the disclosure an innovation that is safe in use.

The disclosure, thus conceived, is susceptible of numerous modifications and variations, all of which are within the scope of the appended claims Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

1-13. (canceled)

14. A method for preparing frozen foods, including the steps of:
washing vegetables to eliminate any residues;
subjecting said vegetables to mechanical treatment to isolate the edible part of said vegetables;
cutting said vegetables into small parts having dimensions comprised between 2 mm and 20 mm, through the use of a cutting device;
cooking said small parts by way of boiling or steaming;
freezing said cooked small parts by way of a freezer to a temperature comprised between −10° C. and −30° C.;
measuring predefined quantities of ingredients which comprise said small parts of vegetables, egg white and at least one regulator for parameters such as flavor enhancement, flavoring, and texture;
homogenizing said ingredients by way of apparatuses for cutting and mixing, producing a homogeneous mixture;
distributing said mixture on at least one surface in order to generate layers of predefined dimensions;
freezing said layers by way of a freezer to a temperature comprised between −10° C. and −30° C.; and
subjecting said layers to surface topping with ingredients chosen from among tomato sauce, cheese, vegetables, soy products, meat, meat products, fish, fish products, oils, and fats.

15. The method according to claim 14, including the steps of:
arranging in adapted containers said layers and proceeding with a respective cooking prior to subjecting layers to topping;
spraying water on layers at the end of the topping process;
freezing the topped and water-sprayed layers by way of a freezer to a temperature comprised between −10° C. and −30° C.;
packaging each topped, water-sprayed and frozen layer; and
storing each package containing at least one topped, water-sprayed and frozen layer in a freezer at a temperature comprised between −10° C. and −30° C.

16. The method according to claim 14, wherein said at least one regulator for parameters such as flavor enhancement and flavoring comprises at least one substance chosen from among kitchen salt, in a quantity of up to 1% of the total by weight, cheese, in a quantity of up to 20% of the total by weight, and at least one part of an aromatic plant, in a quantity up to 2% of the total by weight.

17. The method according to claim 14, wherein said at least one regulator of texture comprises at least one cereal flour, in a quantity of up to 60% of the total by weight.

18. The method according to claim 14, wherein between said step of freezing said cooked small parts of vegetables and said step of measuring predefined quantities of ingredients there is at least one intermediate step of storing and transferring said cooked and frozen small parts of vegetables.

19. The method according to claim 14, wherein said step of distributing said mixture on at least one surface, in order to generate layers thereof of predefined dimensions, is carried out by way of a forming unit.

20. A frozen food of predominantly plant origin, which comprises a base and a topping, said base comprising at least one vegetable in a percentage by weight comprised between 40% and 90%, egg white in a percentage by weight comprised between 2% and 20%, and at least one regulator for parameters such as flavor enhancement, flavoring, or texture in a percentage by weight comprised between 0.1% and 35%.

21. The food according to claim 20, wherein said at least one vegetable is present in a percentage by weight comprised between 60% and 80%, and said egg white is present in a percentage by weight comprised between 5% and 10%.

22. The food according to claim 20, wherein said at least one regulator for parameters such as flavor enhancement, and flavoring comprises kitchen salt, in a percentage not greater than 0.5% by weight on the total, cheese, in a percentage not greater than 25% by weight on the total, and at least one part of an aromatic plant, in a percentage of up to 2% by weight on the total.

23. The food according to claim 20, wherein said at least one regulator of the texture of the mixture of ingredients that constitute said base prior to being subjected to cooking comprises at least one cereal flour, in a percentage not greater than 60% by weight on the total, and at least one raising agent.

24. The food according to claim 20, wherein said topping comprises ingredients selected from among tomato sauce, cheese, vegetables, soy products, meat, meat products, fish, fish products, oils, and fats.

25. The food according to claim 24, wherein said vegetables comprise a residue of pesticides lower than a preset threshold of 0.01 mg/Kg.

26. The food according to claim 24, wherein said vegetables originate from organic agriculture.
